(19) United States
(12) Patent Application Publication
(10) Pub. No.: US 2023/0206037 A1
(43) Pub. Date: Jun. 29, 2023

(54) METHODS AND ARRANGEMENTS FOR LIMIT ANALYSIS AND OPTIMIZATION

(71) Applicant: State Street Bank and Trust Company, Boston, MA (US)

(72) Inventor: Patrick James Wetmore, Dunstable, MA (US)

(73) Assignee: State Street Bank and Trust Company, Boston, MA (US)

(21) Appl. No.: 18/074,202

(22) Filed: Dec. 2, 2022

Related U.S. Application Data
(60) Provisional application No. 63/285,643, filed on Dec. 3, 2021.

(51) Int. Cl. G06N 3/048

(52) U.S. Cl. CPC G06N 3/048

(57) ABSTRACT

Logic may integrate one or more neural networks into optimization. Logic may create function data structures representing the functionality of a neural network. Logic may determine a function data structure by generating a graph or tree based data structure for input values. Logic may determine a function data structure by generating a graph or tree based data structure for each node in each layer and incorporating formulas for activation functions associated with the nodes, as needed. Logic may generate a matrix including an array of weights to represent a neural network. Logic may evaluate each of the nodes in a function data structure from an input layer through an output layer. And logic may recursively evaluate each of the nodes in each of the layers for neural networks that are not recurrent neural networks.

### CROSS-REFERENCE TO RELATED APPLICATIONS

This application claims the benefit of and priority to U.S. Provisional Application No. 63/285,643, filed on Dec. 3, 2021, the entire disclosure of which is hereby incorporated by reference herein in its entirety for all purposes.

### TECHNICAL FIELD

Embodiments described herein are in the field of limit analysis and optimization. More particularly, the embodiments relate to methods and arrangements to facilitate integration of machine learning such as neural networks as constraints and/or objective functions with limit analysis and optimization.

### BACKGROUND

Compliance rules are rules that determine whether financial regulations are being followed, and whether portfolio goals are being met (e.g., only 30% of a particular fund may be invested in equities).

Limit analysis treats compliance rules as mathematical equations that find quantities to satisfy all rules/equations, which enables you to buy or sell the largest quantity possible without violating compliance rules. This allows portfolio managers to view the limits while creating orders, such that they do not attempt to create any orders that violate compliance rules.

Optimization maximizes or minimizes an objective while still satisfying a group of constraints. In finance, for instance, in the field of portfolio management, an optimizer may minimize portfolio risk while ensuring generated order quantities satisfy all compliance rules.

### BRIEF DESCRIPTION OF THE DRAWINGS

FIGS. 1A-B depict embodiments of systems including servers, networks, and user devices to convert neural networks for integration into optimization and/or limit analysis;

FIGS. 1C-D depict embodiments of a neural network, such as the constraint neural network(s) 1017 and the objective function neural network(s) 1018 illustrated in FIG. 1A;

FIG. 1E depicts an embodiment of input values for a neural network created as a directed acyclic graph for an input layer, such as the input layer shown in FIG. 1D;

FIG. 1F depicts an embodiment of an input layer, weights, and a hidden layer created from a neural network into a directed acyclic graph such as the neural network shown in FIG. 1D;

FIG. 1G depicts an embodiment of an input layer, weights, a hidden layer, and an output layer created from a neural network into a directed acyclic graph such as the neural network shown in FIG. 1D;

FIGS. 1H-1I depict two-dimensional and three-dimensional embodiments of graphical representations of constraint functions and objective functions output from an optimizer to display on a user device such as the user device shown in FIG. 1D;

FIG. 2 depicts an embodiment of input data structure generation logic circuitry, such as the input data structure generation logic circuitry shown in FIGS. 1A-1B;

FIGS. 3A-E depict flowcharts of embodiments to create and implement function data structures, by input data structure generation logic circuitry, such as the input data structure generation logic circuitry shown in FIGS. 1A-1B;

FIG. 4 depicts an embodiment of a system including a multiple-processor platform, a chipset, buses, and accessories such as the servers and user device shown in FIGS. 1A-1B; and

FIGS. 5-6 depict embodiments of a storage medium and a computing platform such as the servers and user device shown in FIGS. 1A-B.

### DETAILED DESCRIPTION OF EMBODIMENTS

The following is a detailed description of embodiments depicted in the drawings. The detailed description covers all modifications, equivalents, and alternatives falling within the appended claims.

Machine learning seeks to learn patterns from large data sets (training sets), and then uses what it learned to evaluate new data sets. For example, finance may involve trade surveillance, ranking, and/or the like. For trade surveillance, machine learning may analyze “good” and “bad” trade data sets and evaluate the quality of new trade data sets. Trade data not matching well to learned “good” trade data may be flagged as suspicious, triggering a review by a compliance team to see the flagged trades. In some embodiments, neural networks trained for trade surveillance may represent constraint neural networks.

For ranking, machine learning may be used for several ranking tests that evaluate the positive effects of a trade. One of these tests may evaluate the likely change in market value of a security. A portfolio manager may wish to rebalance a portfolio while maximizing the likely change in market value. Some embodiments may allow a likely market value to be maximized without violating compliance rules. In some embodiments, neural networks trained for ranking may represent objective function neural networks.

Contemporary optimizers may not use neural networks as constraint or objective function inputs. Thus, embodiments may advantageously integrate machine learning models such as neural networks into limit analysis and optimization. Many embodiments advantageously convert neural networks into function data structures compatible with an input of an optimizer and/or compatible with an input of a limit analyzer such as graph-based or tree-based data structures. In some embodiments, a neural network may be converted via graph vertex types already known to the optimizer or limit analyzer such as a directed acyclic graph (DAG).

In other embodiments, a neural network may be converted by creating graph or tree based data structures to represent the input values and creating a new vertex containing a three dimensional array of weights between the input layer and the output layer. The three dimensional array of weights may comprise a first dimension to represent a current layer, a second dimension to represent a current node in the current layer, and a third dimension to represent a current weight between the current node and a prior node on a prior layer. In such embodiments, each node may be associated with a solve function embedding logic or calls to logic to evaluate each node and the evaluation of each node may be stored variables associated with the each of the nodes in each of the layers. Still other embodiments may embed logic or calls to logic to evaluate nodes in each layer, store the results of evaluation in an array of current results, and move the current results into an array of prior results when evaluating a subsequent layer.

One contemporary use of machine learning with optimization may teach a neural network to produce an optimized result given specified constraints. Consider the example of a self-driving car: instead of having two neural networks where a first neural network evaluates (optimizes) an objective function to “drive forward” and a second neural network evaluates (constrains) the optimized output to attain the objective with a constraint function of “don't cross the center line”, it is far easier to have a single neural network trained to do both tasks at once, producing optimized output based on the constraints.

In some situations, the use of a neural network trained for optimizing based on constraints is not feasible because such use of neural networks does not offer precision. Some embodiments may advantageously use one or more neural networks as objective functions and one or more neutral networks as constraint functions for situations in which explicitly defined external functions must be solved exactly, rather than approximated, via a neural network. For instance, the world of finance has legal regulations that must be adhered to exactly, and exceeding regulatory limits by even small amounts can have legal consequences.

Limit analysis is another situation in which a neural network must produce the exact results necessary. While contemporary use of a neural network is to evaluate a data set, situations such as in finance may necessitate determination of the input(s) that will produce the exact results in advance of actually evaluating the neural network. In such situations, the inputs may be formulas applied to the actual input variable being solved (e.g., the market value as an input would be the product of the market price and the variable quantity). Many embodiments may advantageously integrate neural networks into technologies such as limit analysis and optimization in the context of, e.g., finance, by converting the neural networks into data structures to generate inputs for limit analysis and optimization.

Some embodiments may convert constraints in the form of neural networks and/or objective functions in the form of neural networks into function data structures that an optimizer can use as inputs to integrate the functionality of the neural networks with the optimizer. Such embodiments may also advantageously allow a client to use an existing optimizer with constraint neural networks to perform limit analysis to determine limits on trades for a financial portfolio. Such embodiments may also advantageously allow a client to use an existing optimizer with constraint and/or objective function neural networks to perform optimization functions such as rebalancing a financial portfolio to minimize risk or maximize value while taking the constraints into account.

Several embodiments comprise systems with multiple processor cores such as central servers, access points, and/or stations (STAs) such as modems, routers, switches, servers, workstations, netbooks, mobile devices (Laptop, Smart Phone, Tablet, and the like), sensors, meters, controls, instruments, monitors, home or office appliances, Internet of Things (IoT) gear (watches, glasses, headphones, and the like), and the like. In various embodiments, these devices relate to specific applications such as healthcare, home, commercial office and retail, security, and industrial automation and monitoring applications, as well as vehicle applications (automobiles, self-driving vehicles, airplanes, drones, and the like), and the like.

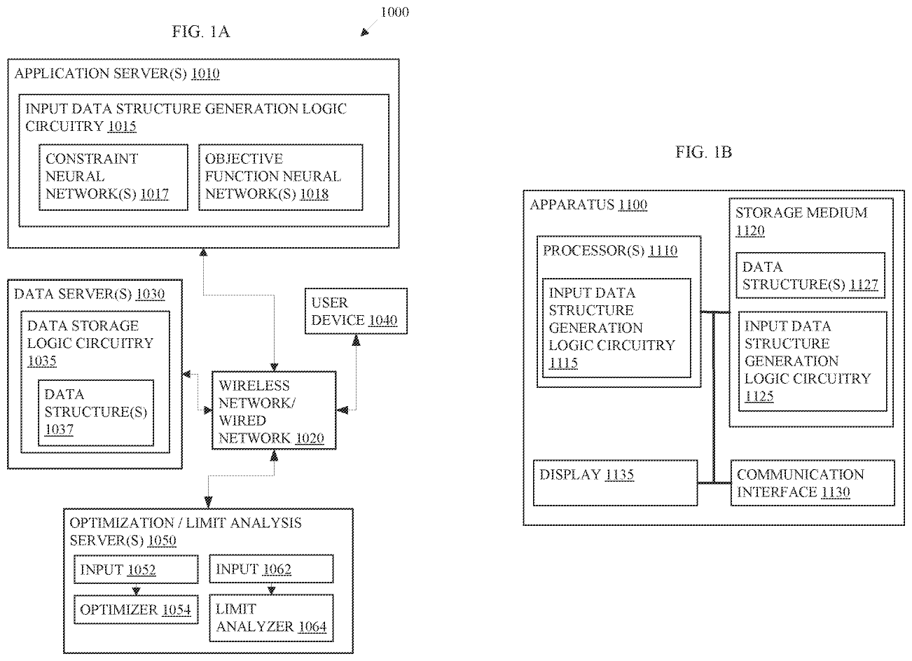

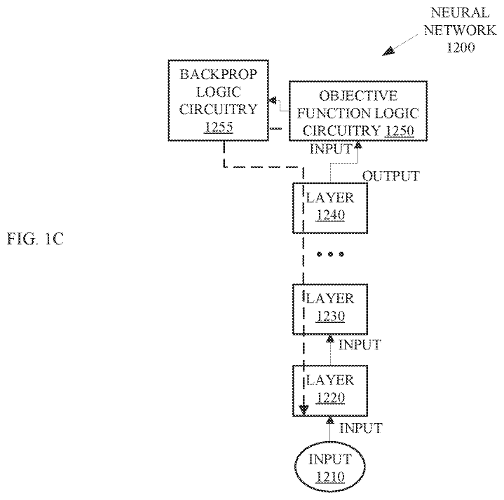

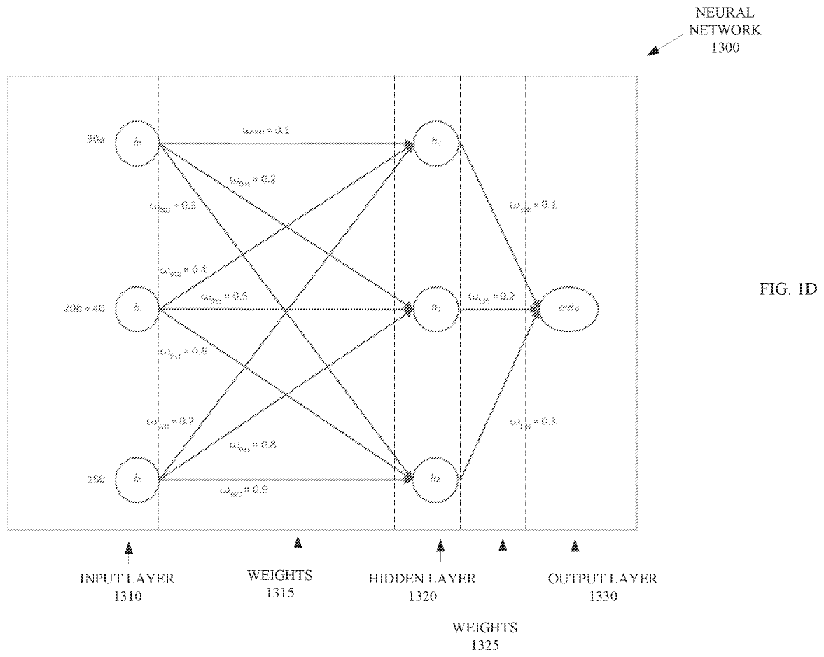

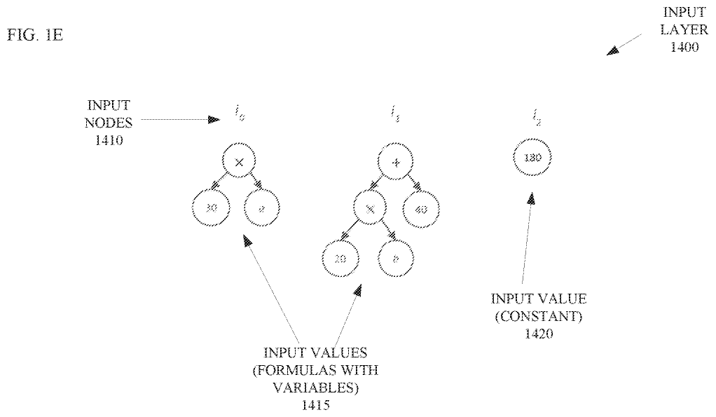

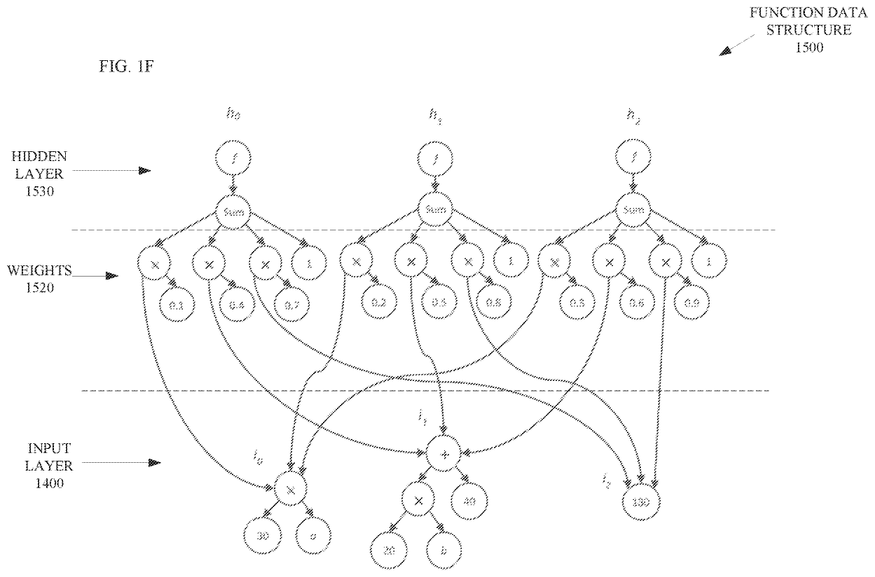

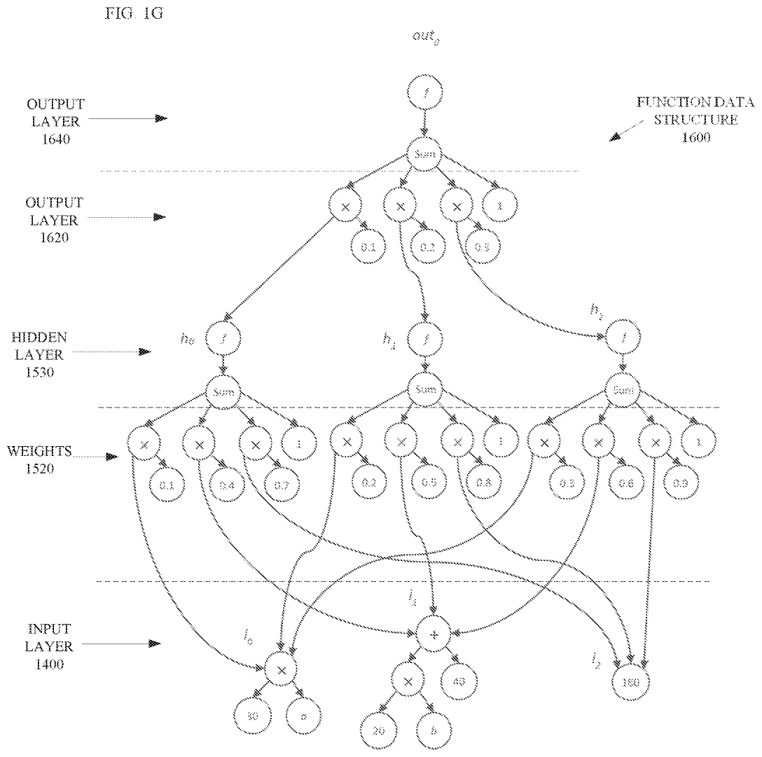

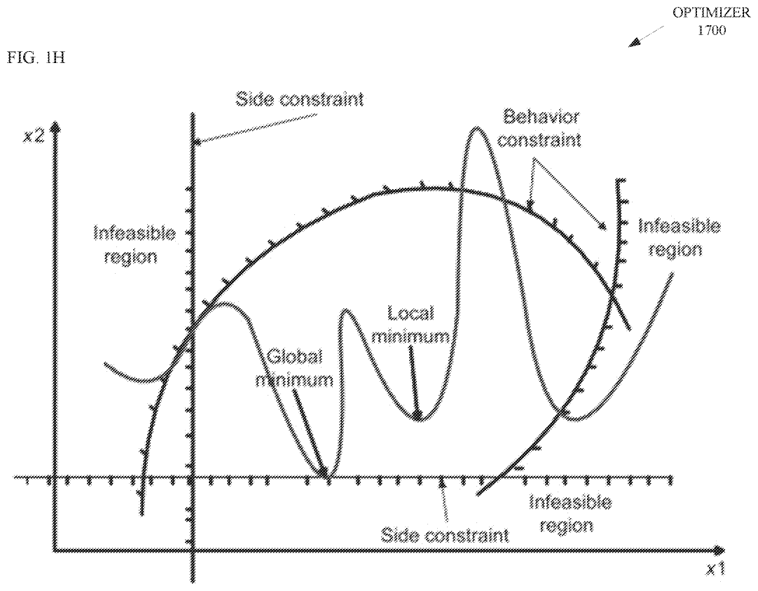

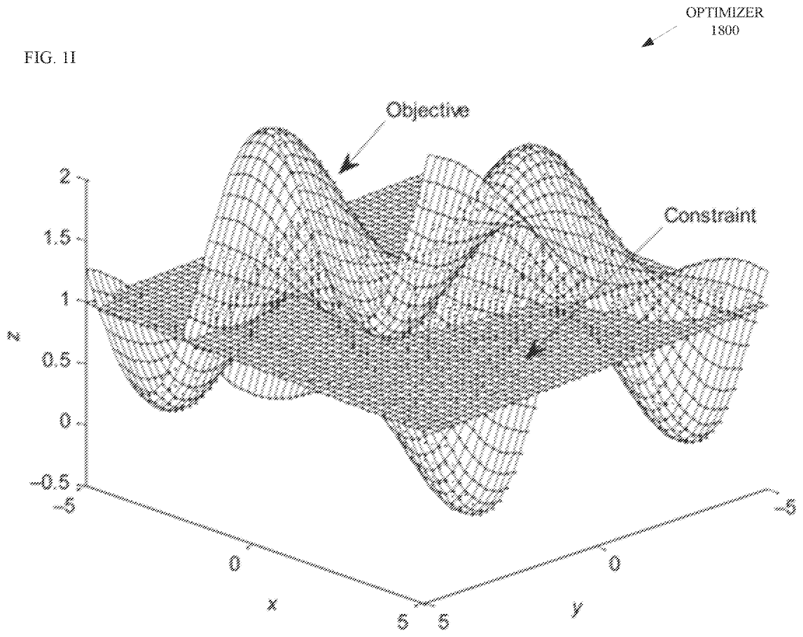

Turning now to the drawings, FIGS. 1A-B depict embodiments of systems including servers, networks, and user devices to convert neural networks for integration into optimization and/or limit analysis. FIG. 1A illustrates an embodiment of a system 1000. The system 1000 may represent a portion of at least one wireless or wired network 1020 that interconnects application server(s) 1010 with data server(s) 1030, user device 1040, and optimization/limit analysis server(s) 1050. The at least one wireless or wired network 1020 may represent any type of network or communications medium, or combination thereof, that can communicatively interconnect the application server(s) 1010 with the data server(s) 1030, user device 1040, and optimization/limit analysis server(s) 1050, such as a cellular service, a cellular data service, satellite service, other wireless communication networks, fiber optic services, other land-based services, and/or the like, along with supporting equipment such as hubs, routers, switches, amplifiers, and/or the like.

In the present embodiment, the application server(s) 1010, data server(s) 1030, user device 1040, and optimization/limit analysis server(s) 1050 may represent one or more servers owned and/or operated by a company that provides financial services. In some embodiments, the application server(s) 1010, data server(s) 1030, user device 1040, and optimization/limit analysis server(s) 1050 represent more than one company that provides financial services. For example, the application server(s) 1010 and data server(s) 1030 may be owned by a service provider company that provides services including converting neural networks such as constraint neural network(s) 1017 and objective function neural network(s) 1018 to function data structures that can integrate with the optimizer 1054 and/or the limit analyzer 1064. For instance, a client company may purchase or subscribe to services from a service provider that owns the application server(s) 1010 and the data server(s) 1030 to facilitate integration of the constraint neural network(s) 1017 and objective function neural network(s) 1018 into the client's existing optimizer 1054 and/or limit analyzer 1064. The client may own the optimization/limit analysis server(s) 1050 and the user device 1040, and the optimization/limit analysis server(s) 1050 may comprise the client's existing optimizer 1054 and limit analyzer 1064.

In some embodiments, the client may pretrain the constraint neural network(s) 1017 to detect, classify, and/or predict transactions that meet or exceed constraints associated with the client's portfolio by training the constraint neural network(s) 1017 with training and validation portions of a training data set. Each data set may include, e.g., a sequence of transactions that occur in a series such as a time series or time sequence of transactions that fall within constraints and/or a time series or time sequence of transactions that fall outside constraints. For instance, one or more of the constraint neural network(s) 1017 may be trained on sets of known-good trades. Such one or more of the constraint neural network(s) 1017 may operate in inference mode to predict whether a pattern of trades in trading data provided to the one or more of the constraint neural network(s) 1017 represent “good” trades by determining the variance of pattern of trades in the trade data from “good” trades learned during training. In several embodiments, the client may continue to provide supervised learning (sporadic or periodic) for “good” trades that fall outside of the “good” trades learned in the original training data.

In some embodiments, the client may pretrain the objective function neural network(s) 1018 to detect, classify, and/or predict a ranking of transactions that maximize the client's portfolio value by training the objective function neural network(s) 1018 with training and validation portions of a training data set. Each data set may include, e.g., a sequence of transactions that occur in a series such as a time series or time sequence of transactions and the causal effect of the transactions on the market value of the assets in the portfolio. Note that fully training a neural network such as the constraint neural network(s) 1017 and the objective function neural network(s) 1018 may involve training the neural networks with sufficient samples of training data to converge the neural networks on solutions for, e.g., multiple predicted transactions or multiple classifications based on different initial conditions or initial states of the neural networks.

The client may operate a workstation such as the user device 1040 and may transmit the trained neural networks such as the constraint neural network(s) 1017 and the objective function neural network(s) 1018 to the application server(s) 1010 via the wireless network/wired network 1020, or physically via a data storage medium such as a flash drive, hard drive, compact disk, digital video disk, Blu-ray disk, and/or the like.

The application server(s)s may include receive the constraint neural network(s) 1017 and the objective function neural network(s) 1018 and may include input data structure generation logic circuitry 1015 to convert the constraint neural network(s) 1017 and the objective function neural network(s) 1018 into one or more function data structures to facilitate integration of the functionality of the constraint neural network(s) 1017 and the objective function neural network(s) 1018 with the optimizer 1054 and/or the limit analyzer 1064.

The input data structure generation logic circuitry 1015 may convert trained neural networks into at least one function database structure for integration with a software application such as an optimizer 1054 and/or a limit analyzer 1064. The optimizer 1054 and limit analyzer 1064 may comprise commercial software packages, software service subscriptions, software developed internally by a company or by a client. The optimizer 1054 may receive input 1052 and, based on the input 1052, generate information for a user such as a portfolio manager related to optimizing part of or an entire portfolio. The optimizer 1054 may maximize or minimize one or more objective functions while still satisfying a group of constraints. The one or more objective functions may optimize the portfolio to maximize the value of the portfolio, may optimize the portfolio to minimize risk, and/or the like. The optimizer 1054 may perform the objective function(s) while maintaining the rebalancing of the portfolio within constraints imposed on the portfolio.

The limit analyzer 1064 may determine limits on variables such as trades of a particular asset based on the input 1062 provided to the limit analyzer 1064. For instance, the limit analyzer 1064 may find quantities of one or more assets to satisfy all constraints, which enables a portfolio manager to know the largest quantity possible to buy or sell without violating compliance rules, where the compliance rules are constraints that may be provided to the input 1062 in the form of equations, functions, graph-based functions, and/or tree-based functions such as a directed acyclic graph (DAG). To illustrate, a portfolio manager operating the user device 1040 may request that the limit analyzer 1064 determine limits on stock trades for Company 1. The limit analyzer 1064 may receive constraints in the form of DAGs because the limit analyzer 1064 may be capable of performing functionality provided in the form of DAGs from the input data structure generation logic circuitry 1015, the user device 1040, and/or other sources such as a database of compliance related constraints. Constants may be provided to the input 1062 in the form of a number such as 25 to, e.g., indicate that the portfolio must maintain at least 25 shares of Company 1 stock as one of the constraints. Formulas may be provided to the input 1062 in the form of a one or more vertices with equations equivalent to functions such as addition, subtraction, multiplication, division, logarithm, and/or the like. The input data structure generation logic circuitry 1015 may also provide a DAG with functionality representative of (or equivalent to) a constraint in the form of a trained constraint neural network. The trained constraint neural network, and the DAG, may represent a complex constraint such as a trade surveillance constraint that monitors for, e.g., trade patterns that are outside a normal trading pattern sufficiently to flag the trade pattern for further scrutiny by internal auditors and/or governmental auditors. The portfolio manager may receive a result of the limit analysis such as buying 10-50 shares, or 71-100 shares of the Company 1 stock is within the constraints and buying 51-70 shares violates the constraints. Such information may allow the portfolio manager to view the limits while creating orders, such that the portfolio manager does not attempt to create any orders that violate compliance rules.

In some embodiments, the input data structure generation logic circuitry 1015 may provide all the input 1052 for the optimizer 1054 and the input 1062 for the limit analyzer 1064. In other embodiments, the input data structure generation logic circuitry 1015 may provide at least part of the input 1052 for the optimizer 1054 and the input 1062 for the limit analyzer 1064.

The input data structure generation logic circuitry 1015 may be capable of converting trained neural networks into one type of function database structure or may be capable of converting the trained neural networks into multiple type of function database structures for integration with an optimizer 1054 and/or a limit analyzer 1064. For example, the input data structure generation logic circuitry 1015 may be capable of converting a trained neural network into a DAG. The input data structure generation logic circuitry 1015 may convert the input values of the neural network into function data structures representing (1) constants, when an input does not depend on any variables being evaluated and (2) formulas using variables (which may be as simple as the variable itself). The vertex types may represent, e.g., a sum operation, having one or more children to be summed together; an arithmetic operation to e.g., multiply, having two children (left and right sides of the multiplication operation); variables; constant values; activation function of the neural network, having a single child that is the argument to the function; comparison operations (equal, not equal, greater than, greater than or equal, less than, or less than or equal); and any additional vertex types needed to represent the input node values as formulas utilizing variables (e.g. Add, division, and subtraction).

The Activation function may instead be a DAG of mathematical operations, with the single child to be used as the argument utilized as a child at one or more places in the graph. Furthermore, the value of each input node may be represented as a DAG using the above vertex types. The DAG of the input values may be comprised of a single constant or variable, or a representation of a mathematical formula utilizing one or more variable vertices.

For each layer of the neural network after the input layer, proceeding from the layer closest to the input all to the desired output node then, for each node in that layer, if the layer is the output layer and the node is not going to be used as a constraint or objective function (or solved for, in the case of limit analysis), continue to the next node without doing further work.

Otherwise, the input data structure generation logic circuitry 1015 may construct a new graph, consisting of a sum vertex. For each connection between the current node and the nodes in the prior layer, the input data structure generation logic circuitry 1015 may add a child to the sum that is a multiply vertex, whose children in turn are a constant containing the weight of the connection to the prior node, and the graph representing the value of the prior node. The input data structure generation logic circuitry 1015 may also then add another child to the sum vertex including a constant containing the bias value and then set the node's value to a new graph consisting of an activation function vertex, with the sum vertex just constructed above as its argument.

For recurrent neural networks, the learning steps (modification of existing weights) can be ignored entirely as only the next output needs to be considered.

For the output layer, the input data structure generation logic circuitry 1015 may retrieve the directed acyclic graphs used as the values from the desired output nodes. For each output node to be used as a constraint, or to be solved for limit analysis, construct a comparison vertex against a “passing” value, using the output node's graph and the passing value as the children (this is unnecessary for objective functions). This comparison should then be passed to the optimizer 1054 as a constraint, or passed to an equation solver such as the limit analyzer 1064 for limit analysis. Alternatively, for each output node to be used as an objective function, pass the graph corresponding to the output node to the optimizer (with no creation of a comparison necessary).

It is to be noted that in order to conserve memory resources, if the optimizer 1054 (or limit analyzer 1064) is modified directly to recognize neural networks as a type of vertex in its graph, the input data structure generation logic circuitry 1015 may store the neural network weights as a three dimensional array, and the equivalent analyses performed as a result of iterations over the array without constructing the full graph, but still utilizing child graphs corresponding to input node values.

If the optimizer 1054 or limit analyzer 1064 provides an interface to implement high level mathematical operations directly (without requiring representation as a graph of discrete lower-level operations), then the input data structure generation logic circuitry 1015 may perform the equivalent of the above algorithm without constructing a graph, instead only holding a three dimensional array of weights representing the layer on one dimension, and the node within the layer on the second dimension, and the weight between that node and the prior node in the third dimension. This allows for a memory savings, as only the weights need to be recorded.

The input data structure generation logic circuitry 1015 may still create the graphs of input node values as its children, one corresponding to each input node, as described above, in addition to the matrix of weights. To build the function data structure, the input data structure generation logic circuitry 1015 may create a new NeuralNetwork vertex with a new NeuralNetwork vertex type available to build the function data structure. The input data structure generation logic circuitry 1015 may add a child vertex per input node to the NeuralNetwork vertex.

The NeuralNetwork vertex may include a three dimensional array of weights ω, with the first dimension of the matrix representing a current layer, the second dimension representing a current node within the current layer, and the third dimension representing a prior node within the previous layer, where the evaluation of the current node is based on the evaluation of the prior node in the previous layer in the neural network. The NeuralNetwork vertex may also include an index of the output node to be evaluated in the output layer.

The optimizer 1054 or limit analyzer 1064 may evaluate the three-dimensional array of weights in different ways. For instance, the optimizer 1054 or limit analyzer 1064 may establish vertices with constants and variables to track the values of the nodes or the optimizer 1054 or limit analyzer 1064 may establish a current results array and a previous results array to store values for the current nodes on the current layer being evaluated as well as maintain the values of the prior layer nodes previously evaluated. With such values, the optimizer 1054 or limit analyzer 1064 may evaluate the nodes represented in the array of weights recursively to evaluate the constraint function or objective function of the neural network.

To illustrate, the optimizer 1054 or limit analyzer 1064 may have recursive function evaluateNode, taking as arguments the layer (represented by numeric index i, with the input layer being layer i=0 and the output layer being i=# of layers−1) and the node (represented by numeric index j). Each vertex in the graph may have function solve, that evaluates the vertex.

If the layer is the input layer (when i=0), evaluateNode may call solve on the graph corresponding to the current input node j and return result as the current node's value.

Otherwise evaluateNode may assign value 0 to a variable sum and, for each node in the prior layer (represented by numeric index k), evaluateNode may recursively call evaluateNode, passing i−1 for the layer and k for the node, to determine the result of evaluation for the prior node; evaluate the multiplication of the aforementioned call to evaluateNode by the weight between the current node and node in the prior layer, ωᵢⱼₖ in array ω; and evaluate the addition of the product of the multiplication to variable sum. evaluateNode may also add the bias to variable sum; evaluate the activation function on variable sum, as required by the optimizer 1054 (or limit analyzer 1064), either by calling solve on a graph equivalent to the activation function, or embedding the corresponding logic within the NeuralNetwork vertex itself; and return evaluation of the activation function as current node's value.

The NeuralNetwork vertex's solve function should call evaluateNode, passing the output layer (i=# of layers−1), and the particular output node it wants to evaluate (j). Note that for recurrent neural networks, the learning steps (modification of existing weights) can be ignored entirely as only the next output needs to be considered.

The recursive nature of the algorithm emulates walking the DAG generated by the original algorithm, while seamlessly walking the graphs assigned as input values to the neural network. The evaluation performed by solve could be a simple arithmetic evaluation (e.g., an Add vertex would return the addition of its left and right hand children), or a more complicated operation such as limit analysis.

As an alternative illustration, the optimizer 1054 or limit analyzer 1064 may iterate over the array of weights in a NeuralNetwork vertex from the input layer to the output layer of the neural network as represented in the array of weights. This is analogous to the traditional method of neural network evaluation, with the normal arithmetic computation of the activation function replaced by evaluation in terms that the optimizer (or limit analysis) uses (e.g., polynomial data structures in limit analysis).

In such embodiments, the optimizer 1054 or limit analyzer 1064 may prepare two arrays of intermediate results, with lengths equal to the maximum number of nodes in a layer, and name the arrays currResults and priorResults. The types of data stored in the two arrays depends on the optimizer 1054 or limit analyzer 1064. For instance, the limit analyzer 1064 may utilize a data structure representing a polynomial.

For each layer in the array of weights (represented by numeric index i, with the input layer being layer i=0 and the output layer being i=# of layers−1) and for each node in the layer (represented by numeric index j), the optimizer 1054 or limit analyzer 1064 may:

(1) If the layer is the input layer (when i=0), call solve on the graph corresponding to the current input node j and store the result in currResultsⱼ.

(2) If the layer is the output layer and j is not equal to the index of the desired output node being evaluated, then continue without doing any work.

(3) Otherwise,
a. Assign value 0 to variable sum;
b. For each node in the prior layer (represented by numeric index k), Perform a multiplication of priorResultsₖ by weight ωᵢⱼₖ and add the product to variable sum
c. Add the bias to variable sum
d. Evaluate the activation function on variable sum, as required by the optimizer (or limit analysis), either by calling solve on a graph equivalent to the activation function, or embedding the corresponding logic within the NeuralNetwork vertex itself
e. Store the result of that evaluation of the activation function in currResultsⱼ

The optimizer 1054 or limit analyzer 1064 may swap currResults and priorResults with each other between each layer iteration. Further, the optimizer 1054 or limit analyzer 1064 may return the result stored in priorResults at the index of the desired output node. Note that for recurrent neural networks, the learning steps (modification of existing weights) can be ignored entirely as only the next output needs to be considered.

FIG. 1B depicts an embodiment for an apparatus 1100 such as one of the application server(s) 1010, the user device 1040, and/or the optimization/limit analysis server(s) 1050 shown in FIG. 1A. The apparatus 1100 may be a computer in the form of a smart phone, a tablet, a notebook, a desktop computer, a workstation, or a server. The apparatus 1100 can combine with any suitable embodiment of the systems, devices, and methods disclosed herein. The apparatus 1100 can include processor(s) 1110, a non-transitory storage medium 1120, communication interface 1130, and a display 1135. The processor(s) 1110 may comprise one or more processors, such as a programmable processor (e.g., a central processing unit (CPU)). The processor(s) 1110 may comprise processing circuitry to implement input data structure generation logic circuitry 1115 such as the input data structure generation logic circuitry 1015 shown in FIG. 1A.

The processor(s) 1110 may operatively couple with a non-transitory storage medium 1120. The non-transitory storage medium 1120 may store logic, code, and/or program instructions executable by the processor(s) 1110 for performing one or more instructions including the input data structure generation logic circuitry 1125. The non-transitory storage medium 1120 may comprise one or more memory units (e.g., removable media or external storage such as a secure digital (SD) card, random-access memory (RAM), a flash drive, a hard drive, and/or the like). The memory units of the non-transitory storage medium 1120 can store logic, code and/or program instructions executable by the processor(s) 1110 to perform any suitable embodiment of the methods described herein. For example, the processor(s) 1110 may execute instructions such as instructions of input data structure generation logic circuitry 1125 causing one or more processors of the processor(s) 1110 represented by the input data structure generation logic circuitry 1115 to perform a conversion of a neural network of such as one or more of the constraint neural network(s) 1017 and one or more of the objective function neural network(s) 1018. The conversion process may create a function data structure, such as a graph-based or tree based structure, that includes the functionality of the original neural network in a form that an optimizer or limit analyzer can process and the processor(s) 1110 may store the function data structure in the data structure(s) 1127 medium or media of the storage medium 1120.

The processor(s) 1110 may couple to a communication interface 1130 to transmit the function data structure to and/or receive neural networks from one or more external devices (e.g., a terminal, display device, a smart phone, a tablet, a server, or other remote device). The communication interface 1130 includes circuitry to transmit and receive communications through a wired and/or wireless media such as an Ethernet interface, a wireless fidelity (Wi-Fi) interface, a cellular data interface, and/or the like. In some embodiments, the communication interface 1130 may implement logic such as code in a baseband processor to interact with a physical layer device to transmit and receive wireless communications from a server such as a function data structure for integration with an optimizer or a limit analyzer such as the optimizer 1054 or the limit analyzer 1064 shown in FIG. 1A. For example, the communication interface 1130 may implement one or more of local area networks (LAN), wide area networks (WAN), infrared, radio, Wi-Fi, point-to-point (P2P) networks, telecommunication networks, cloud communication, and the like.

The processor(s) 1110 may couple to a display 1130 to display a message or notification via, graphics, video, text, and/or the like. In some embodiments, the display 1130 may comprise a display on a terminal, a display device, a smart phone, a tablet, a server, or a remote device.

FIGS. 1C-D depict embodiments of a neural network, such as the constrain neural network(s) 1017 and the objective function neural network(s) 1018 illustrated in FIG. 1A. FIG. 1C depicts an embodiment of stages of a neural network (NN) 1200 such as a recurrent neural network (RNN).

An RNN is a class of artificial neural network where connections between nodes form a directed graph along a sequence. This allows the RNN to exhibit dynamic temporal behavior for a time sequence. RNNs can use their internal state (memory) to process sequences of inputs and can have a finite impulse structure or an infinite impulse structure. A finite impulse recurrent network is a directed acyclic graph that can be unrolled and replaced with a strictly feedforward neural network, while an infinite impulse recurrent network is a directed cyclic graph that cannot be unrolled. A feedforward neural network is a neural network in which the output of each layer is the input of a subsequent layer in the neural network rather than having a recursive loop at each layer.

The neural network 1200 comprises an input layer 1210, and three or more layers 1220 and 1230 through 1240. The input layer 1210 may comprise input data that is training data for the neural network 1200 to evaluate. The input layer 1210 may provide the training data in the form of tensor data to the layer 1220. The training data may comprise transaction information, which is data related to “good” and/or “bad” trades associated with a financial portfolio. The training data may include value information, transaction type information, time information, and/or the like.

In many embodiments, the input layer 1210 is not modified by backpropagation. Backpropagation may facilitate supervised learning by adjusting weights and/or biases throughout the neural network 1200 based on expected and/or correct outputs from the neural network 1200 in response to a given set of inputs. The layer 1220 may compute an output and pass the output to the layer 1230. Layer 1230 may determine an output based on the input from layer 1220 and pass the output to the next layer and so on until the layer 1240 receives the output of the second to last layer in the neural network 1200.

The layer 1240 may generate an output and pass the output to an objective function logic circuitry 1250. The neural network used as an objective function logic circuitry 1250 may determine errors in the output from the layer 1240 based on an objective function such as a comparison of the expected output against the actual output. For instance, the expected output may be paired with the input in the training data supplied for the neural network 1200 for supervised training. When operating in inference mode, the input data structure generation logic circuitry, such as the input data structure generation logic circuitry 1115 shown in FIG. 1B, may compare the output of the objective function logic circuitry 1250 against the deviation threshold to determine if the error indicates, e.g., a pattern of trades that fall outside a trade surveillance constraint, or a “bad” pattern of trades.

During the training mode, the neural network used as an objective function logic circuitry 1250 may output errors to backpropagation logic circuitry 1255 to backpropagate the errors through the neural network 1200. For instance, the objective function logic circuitry 1250 may output the errors in the form of a gradient of the objective function with respect to the parameters of the neural network 1200.

The backpropagation logic circuitry 1255 may propagate the gradient of the objective function from the top-most layer, layer 1240, to the bottom-most layer, layer 1220 using the chain rule. The chain rule is a formula for computing the derivative of the composition of two or more functions. That is, if f and g are functions, then the chain rule expresses the derivative of their composition f∘g (the function which maps x to f(g(x))) in terms of the derivatives of f and g. After the objective function logic circuitry 1250 computes the errors, backpropagation logic circuitry 1255 backpropagates the errors. The backpropagation is illustrated with the dashed arrows.

FIG. 1D depicts an alternative view of an embodiment of stages of a neural network 1300 such as the neural network shown in FIG. 1D. The neural network 1300 may be, e.g., a convolutional neural network (CNN). A CNN is a class of deep, feed-forward artificial neural networks. A CNN may comprise of an input layer and an output layer, as well as one or more hidden layers. The hidden layers of a CNN typically consist of convolutional layers, pooling layers, fully connected layers, and normalization layers. Note that the neural network 1300 is a simple neural network for the purposes of illustration. In other embodiments, the neural network may include more input nodes such as the input nodes i0, i1 and i2; more hidden layer nodes such as h0, h1, and h2, and more layers.

In the FIG. 1D, the inputs to the neural network 1300 may represent the market value of an order of equity “a” ($30 price times an undetermined order quantity, represented by variable a), the market value of holdings in equity “b” ($20 price times an undetermined order quantity, represented by variable b, plus an existing position worth $40), and a non-variable market value of an existing position in equity “c”, $180.

The second, hidden layer nodes may have values determined for a feed-forward neural network—the sum of inputs multiplied by weights ω, plus a bias, passed through an activation function. The output node, out₀, is likewise the sum of hidden node values multiplied by weights 1325, plus a bias (1 in this example), passed through an activation function ƒ.

The neural network 1300 includes an input layer 1310 to receive input data. The input layer 1310 may comprise input data that is new transaction data to evaluate. In the present embodiment, the input layer 1310 includes three nodes. The input data for node i₀ is 30a. 30a represents a variable “a” multiplied by the constant “30”. The input data for node i₁ is 20b+40, which represents the constant “20” multiplied by a variable “b” and added to the constant “40”. And the input data for node i₂ is 180, which represents the constant “180”.

The weights 1315 illustrate interconnections between the input nodes and the hidden layer nodes. Note that the number of nodes in the hidden layer 1320 does not have to be the same as the number of nodes in the input layer 1310.

The weights 1315 include multiplication factors, or weights, represented by the Greek letter omega (ω). The arrows represent combinations that may be, in some embodiments, summed at the hidden nodes in the hidden layer 1320. For example, the hidden node h₂ is a combination of i₀ multiplied by ω₀₀₀, i₁ multiplied by ω₀₁₀, and i₂ multiplied by ω₀₂₀. In the present example, h₀=i₀*ω₀₀₀+i₁*ω₀₁₀+i₂*ω₀₂₀. Substituting the values, h₀ equals 30a*0.1+(20b+40)*0.4+180*0.7. Each of the other hidden nodes can be determined in a similar manner.

In other embodiments, the hidden layer nodes may each apply an activation function and, in some embodiments, a pre-activation function, that presents an equation of discrete time representations of the value function with weights and biases.

Each layer such as the hidden layer 1320 may compute an output and pass the output of the layer 1320 to the input of the next layer, such as the output layer 1330. The output layer 1330 may generate an output based on the activation function of the output node, out₀, and pass the output to an objective function logic circuitry such as the objective function logic circuitry 1250 shown in FIG. 1C.

FIG. 1E depicts an embodiment of input generated for an input layer 1400 such as the input layer 1310 shown in FIG. 1D for a constraint neural network or an objective function neural network such as the constraint neural network(s) 1017 and objective function neural network(s) 1018 shown in FIG. 1A by input data structure generation logic circuitry such as the input data structure generation logic circuitry 1015 shown in FIG. 1A. The input data structure generation logic circuitry may create the input data for input nodes 1410 i₀, i₁, and i₂ in a graph or tree based format such as a directed acyclic graph (DAG). For illustration, the input data is the same as the input data shown in FIG. 1D so the input data for i₀ is 30a, the input data for i₁ is 20b+40, and the input data for i₂ is 180.

The input values for i₀ and i₁ include formulas with variables 1415 and the input value for i₂ is a constant 1420. To generate the input data, the input data structure generation logic circuitry may generate a Multiplication vertex as the graph for i₀ with add two child vertices. One child vertex is a constant “30” and the other child node is a variable “a”.

For i₁, the input data structure generation logic circuitry may generate an Addition vertex as the graph for i₁ and add two child vertices, one Multiplication vertex and one vertex as a constant “40”. The input data structure generation logic circuitry may create two child vertices off the child Multiplication vertex including a constant “20” and a variable “b”.

For i₂, the input data structure generation logic circuitry may generate a vertex with a constant “180”. Note that the input data structure generation logic circuitry may create more complex input values by adding more child vertices linked to each vertex. In some embodiments, the input data structure generation logic circuitry may create more complex input values by adding one or two child vertices to each child vertex until the complete function is graphed. In other embodiments, the input data structure generation logic circuitry may create more complex input values by adding more than two child vertices per vertex. Furthermore, some embodiments may advantageously include more operations than addition and multiplication such as subtraction, division, exponent, logarithm, and/or the like. Some embodiments include such operations for tensors and/or matrices.

FIG. 1F depicts an embodiment of a function data structure 1500 including the input layer 1400, weights 1520, and a hidden layer 1530 created from a neural network into a directed acyclic graph such as the neural network 1300 shown in FIG. 1D by input data structure generation logic circuitry such as the input data structure generation logic circuitry 1015 shown in FIG. 1A. The input data structure generation logic circuitry may create the input data for input nodes i₀, i₁, and i₂ in the input layer in a graph or tree based format such as a directed acyclic graph (DAG). For illustration, the input data is the same as the input data shown in FIGS. 1D and 1E so the input data for i₀ is 30a, the input data for i₁ is 20b+40, and the input data for i₂ is 180.

The input data structure generation logic circuitry may create nodes for each node in the hidden layer of the neural network including child nodes to implement the activation function for each of the hidden layer nodes h₀, h₁, and h₂. For h₀, the input data structure generation logic circuitry may create a summation vertex to add the child nodes. Furthermore, the input data structure generation logic circuitry may, due to the construction of the neural network 1300, create one multiplication vertex for each input value (i₀, i₁, and i₂) and connect the multiplication vertex to a graph of the input value in the input layer 1400 and to a child vertex for each respective weight in the weights 1520 to implement the weights 1315 of the neural network 1300 shown in FIG. 1D. For instance, the summation vertex for h₀ includes a multiplication vertex for input value i₀ with a child vertex having the constant “0.1”. The summation vertex for h₀ includes a multiplication vertex for input value i₁ with a child vertex having the constant “0.4”. The summation vertex for h₀ includes a multiplication vertex for input value i₂ with a child vertex having the constant “0.7”. Furthermore, the summation vertices for h₀ as well as h₁ and h₂ also include a child vertex with the constant “1” to add a bias to the activation functions of the hidden layer nodes h₀, h₁, and h₂. The vertices for h₀ as well as h₁ and h₂ are activation functions ƒ with their respective summations as child vertices.

The graph for h₀ is the activation function ƒ calculated on the summation of (0.1*i₀, 0.4*i₁, 0.7*i₂, 1), which is ƒ(0.1*30*a+0.4*(20*b+40)+0.7*180+1). The graph h₁ is the activation function ƒ calculated on the summation of (0.2*i₀, 0.5*i₁, 0.8*i₂, 1), which is ƒ(0.2*30*a+0.5*(20*b+40)+0.8*180+1). The graph h₂ is the activation function ƒ calculated on the summation of (0.3*i₀, 0.6*i₁, 0.9*i₂,1), which is ƒ(0.3*30*a+0.6*(20*b+40)+0.9*180+1).

FIG. 1G depicts an embodiment of a function data structure 1600 including the input layer 1400, the weights 1520, the hidden layer 1530, and adds an output layer 1640 created from a neural network into a directed acyclic graph such as the neural network 1300 shown in FIG. 1D by input data structure generation logic circuitry such as the input data structure generation logic circuitry 1015 shown in FIG. 1A. The input data structure generation logic circuitry may create the output layer 1640 to add to the function data structure 1500 shown in FIG. 1F.

The input data structure generation logic circuitry may create the output layer 1640 by generating a summation vertex; adding a child vertex for multiplication for each hidden layer node h₀, h₁, and h₂. The input data structure generation logic circuitry may add a child vertex to the multiplication vertex for each weight in weights 1620 associated with a hidden layer node in the weights 1325 shown in FIG. 1D; add a child vertex to the multiplication vertex for the output of each hidden layer node (h₀, h₁, and h₂); and add a child vertex with the constant “1” to implement the bias for the output node activation function from the neural network 1300. For instance, the summation vertex includes a child vertex for multiplication of the output of hidden layer node ho and a child vertex with a constant “0.1” in the weights 1620 to represent the weights 1325 of the neural network 1300 shown in FIG. 1D. The summation vertex includes a child vertex for multiplication of the output of hidden layer node h₁ and a child vertex with a constant “0.2” in the weights 1620 to represent the weights 1325. The summation vertex includes a child vertex for multiplication of the output of hidden layer node h₂ and a child vertex with a constant “0.3” in the weights 1620 to represent the weights 1325. The summation vertex includes a child vertex with a constant “1” to add a bias to the activation function. The vertex corresponding to the graph represented by output node out₀ is an activation function ƒ, with its child vertex being the summation vertex (its argument).

FIGS. 1H-1I depict two-dimensional and three-dimensional embodiments of graphical representations of constraint functions and objective functions input as results from an optimizer to display on a user device such as the user device 1040, constraint neural network(s) 1017, objective function neural network(s) 1018, input 1052, optimizer 1054 shown in FIG. 1A.

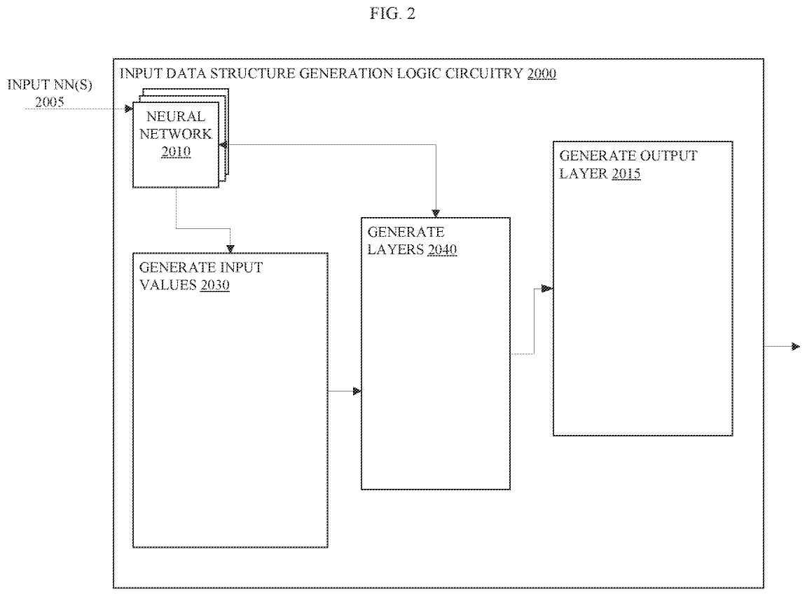

FIG. 2 depicts an embodiment of input data structure generation logic circuitry, such as the input data structure generation logic circuitry shown in FIGS. 1A-1B.

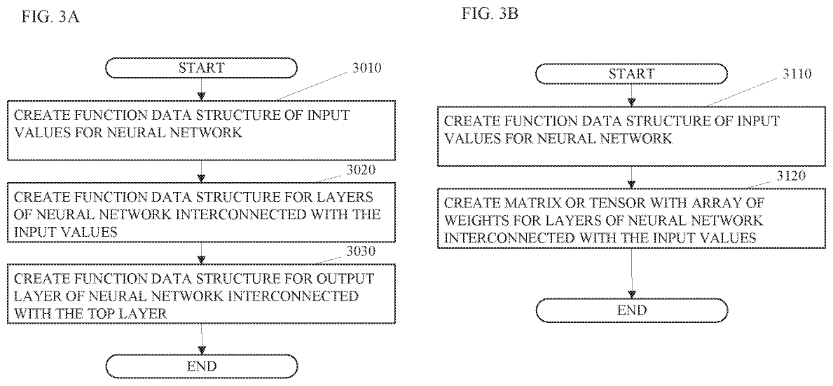

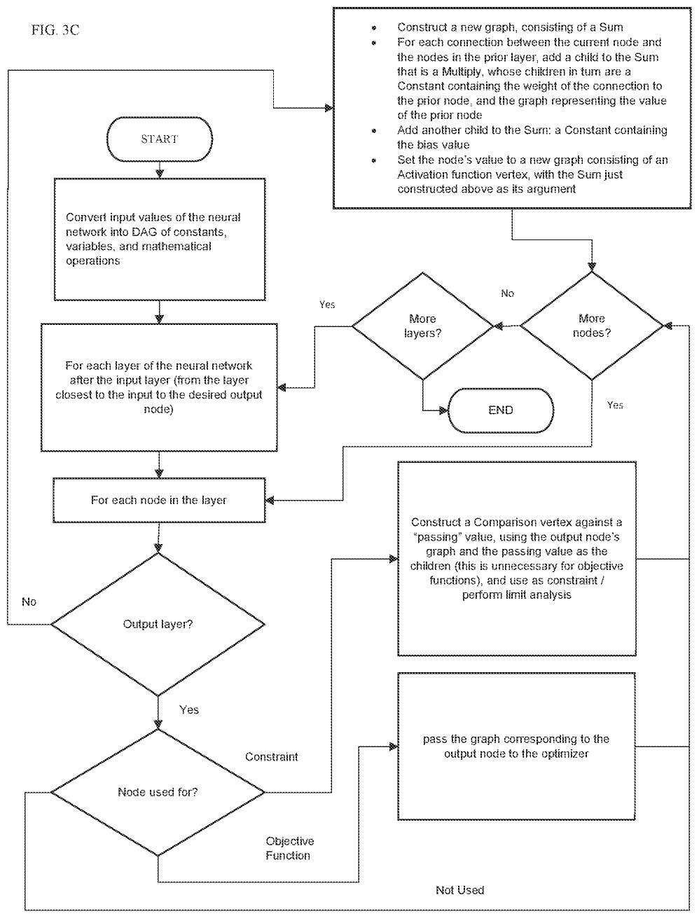

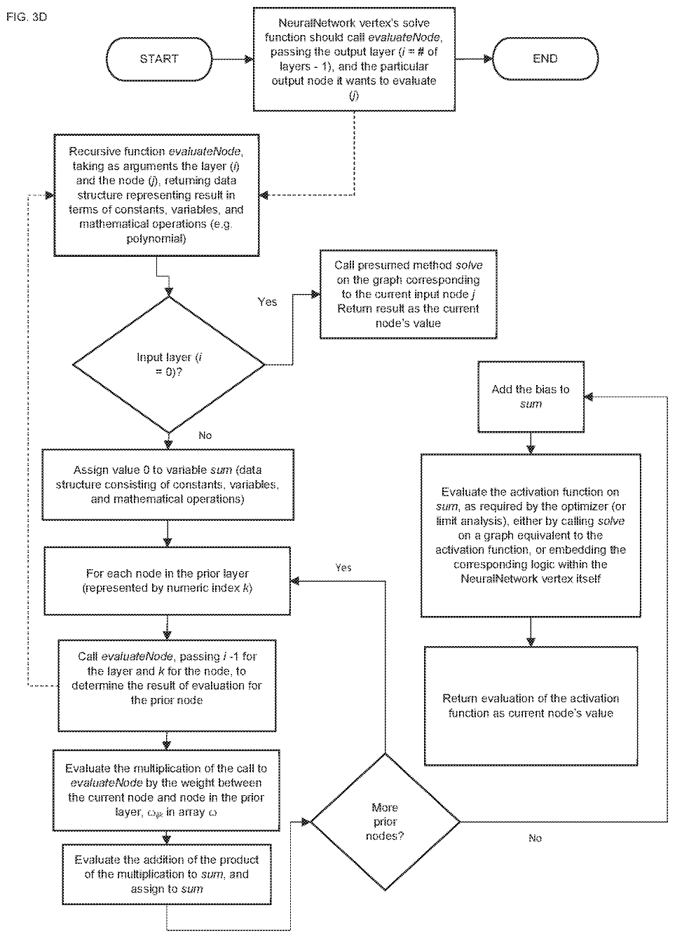

FIGS. 3A-E depict flowcharts of embodiments to create and implement function data structures, by input data structure generation logic circuitry, such as the input data structure generation logic circuitry shown in FIGS. 1A-1B.

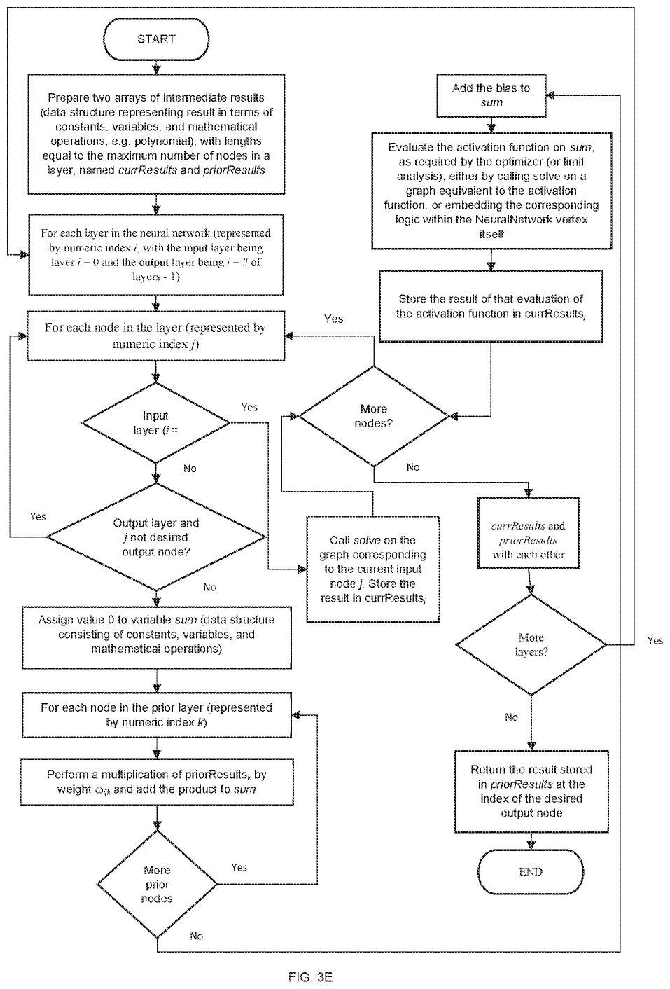

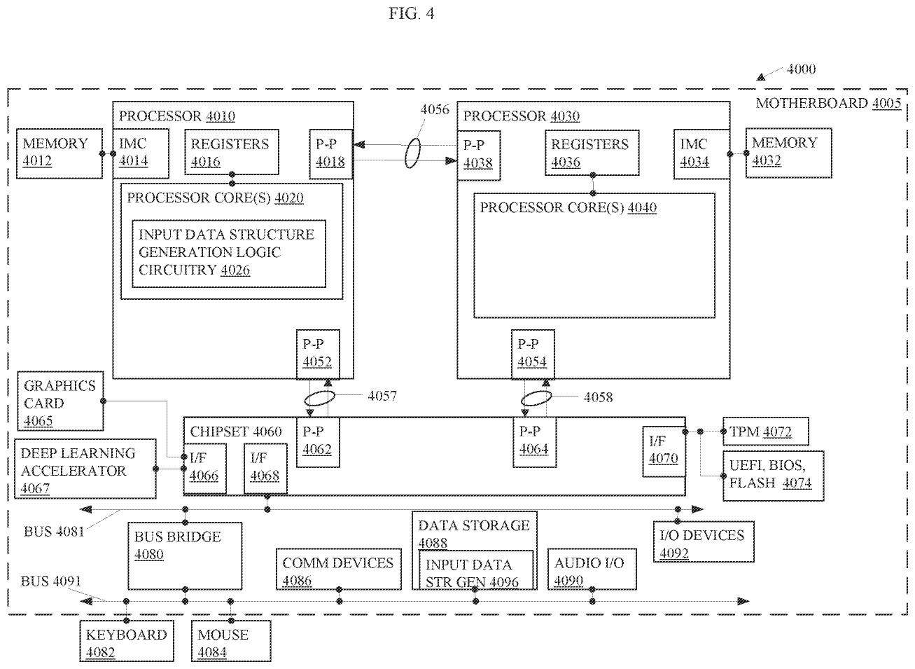

FIG. 4 illustrates an embodiment of a system 4000. The system 4000 is a computer system with multiple processor cores such as a distributed computing system, supercomputer, high-performance computing system, computing cluster, mainframe computer, mini-computer, client-server system, personal computer (PC), workstation, server, portable computer, laptop computer, tablet computer, handheld device such as a personal digital assistant (PDA), or other device for processing, displaying, or transmitting information. Similar embodiments may comprise, e.g., entertainment devices such as a portable music player or a portable video player, a smart phone or other cellular phone, a telephone, a digital video camera, a digital still camera, an external storage device, or the like. Further embodiments implement larger scale server configurations. In other embodiments, the system 4000 may have a single processor with one core or more than one processor. Note that the term “processor” refers to a processor with a single core or a processor package with multiple processor cores.

As shown in FIG. 4, system 4000 comprises a motherboard 4005 for mounting platform components. The motherboard 4005 is a point-to-point interconnect platform that includes a first processor 4010 and a second processor 4030 coupled via a point-to-point interconnect 4056 such as an Ultra Path Interconnect (UPI). In other embodiments, the system 4000 may be of another bus architecture, such as a multi-drop bus. Furthermore, each of processors 4010 and 4030 may be processor packages with multiple processor cores including processor core(s) 4020 and 4040, respectively. While the system 4000 is an example of a two-socket (2S) platform, other embodiments may include more than two sockets or one socket. For example, some embodiments may include a four-socket (4S) platform or an eight-socket (8S) platform. Each socket is a mount for a processor and may have a socket identifier. Note that the term platform refers to the motherboard with certain components mounted such as the processors 4010 and the chipset 4060. Some platforms may include additional components and some platforms may only include sockets to mount the processors and/or the chipset.

The first processor 4010 includes an integrated memory controller (IMC) 4014 and point-to-point (P-P) interconnects 4018 and 4052. Similarly, the second processor 4030 includes an IMC 4034 and P-P interconnects 4038 and 4054. The IMC's 4014 and 4034 couple the processors 4010 and 4030, respectively, to respective memories, a memory 4012 and a memory 4032. The memories 4012 and 4032 may be portions of the main memory (e.g., a dynamic random-access memory (DRAM)) for the platform such as double data rate type 3 (DDR3) or type 4 (DDR4) synchronous DRAM (SDRAM). In the present embodiment, the memories 4012 and 4032 locally attach to the respective processors 4010 and 4030. In other embodiments, the main memory may couple with the processors via a bus and shared memory hub.

The processors 4010 and 4030 comprise caches coupled with each of the processor core(s) 4020 and 4040, respectively. In the present embodiment, the processor core(s) 4020 of the processor 4010 include an input data structure generation logic circuitry 4026 such as the input data structure generation logic circuitry 1015, 1115, and 1125 shown in FIGS. 1A-1B. The input data structure generation logic circuitry 4026 may represent circuitry configured to implement the functionality of input data structure generation for neural networks within the processor core(s) 4020 or may represent a combination of the circuitry within a processor and a medium to store all or part of the functionality of the input data structure generation logic circuitry 4026 in memory such as cache, the memory 4012, buffers, registers, and/or the like. In several embodiments, the functionality of the input data structure generation logic circuitry 4026 resides in whole or in part as code in a memory such as the input data structure generation logic circuitry 4096 in the data storage unit 4088 attached to the processor 4010 via a chipset 4060 such as the input data structure generation logic circuitry 1125 shown in FIG. 1B. The functionality of the input data structure generation logic circuitry 4026 may also reside in whole or in part in memory such as the memory 4012 and/or a cache of the processor. Furthermore, the functionality of the input data structure generation logic circuitry 4026 may also reside in whole or in part as circuitry within the processor 4010 and may perform operations, e.g., within registers or buffers such as the registers 4016 within the processor 4010, or within an instruction pipeline of the processor 4010.

In other embodiments, more than one of the processor 4010 and 4030 may comprise functionality of the input data structure generation logic circuitry 4026 such as the processor 4030 and/or the processor within the deep learning accelerator 4067 coupled with the chipset 4060 via an interface (I/F) 4066. The I/F 4066 may be, for example, a Peripheral Component Interconnect-enhanced (PCI-e).

The first processor 4010 couples to a chipset 4060 via P-P interconnects 4052 and 4062 and the second processor 4030 couples to a chipset 4060 via P-P interconnects 4054 and 4064. Direct Media Interfaces (DMIs) 4057 and 4058 may couple the P-P interconnects 4052 and 4062 and the P-P interconnects 4054 and 4064, respectively. The DMI may be a high-speed interconnect that facilitates, e.g., eight Giga Transfers per second (GT/s) such as DMI 3.0. In other embodiments, the processors 4010 and 4030 may interconnect via a bus.

The chipset 4060 may comprise a controller hub such as a platform controller hub (PCH). The chipset 4060 may include a system clock to perform clocking functions and include interfaces for an I/O bus such as a universal serial bus (USB), peripheral component interconnects (PCIs), serial peripheral interconnects (SPIs), integrated interconnects (I2Cs), and the like, to facilitate connection of peripheral devices on the platform. In other embodiments, the chipset 4060 may comprise more than one controller hub such as a chipset with a memory controller hub, a graphics controller hub, and an input/output (I/O) controller hub.

In the present embodiment, the chipset 4060 couples with a trusted platform module (TPM) 4072 and the unified extensible firmware interface (UEFI), BIOS, Flash component 4074 via an interface (I/F) 4070. The TPM 4072 is a dedicated microcontroller designed to secure hardware by integrating cryptographic keys into devices. The UEFI, BIOS, Flash component 4074 may provide pre-boot code.

Furthermore, chipset 4060 includes an I/F 4066 to couple chipset 4060 with a high-performance graphics engine, graphics card 4065. In other embodiments, the system 4000 may include a flexible display interface (FDI) between the processors 4010 and 4030 and the chipset 4060. The FDI interconnects a graphics processor core in a processor with the chipset 4060.

Various I/O devices 4092 couple to the bus 4081, along with a bus bridge 4080 which couples the bus 4081 to a second bus 4091 and an I/F 4068 that connects the bus 4081 with the chipset 4060. In one embodiment, the second bus 4091 may be a low pin count (LPC) bus. Various devices may couple to the second bus 4091 including, for example, a keyboard 4082, a mouse 4084, communication devices 4086 and a data storage unit 4088 that may store code such as the fraud detection logic circuitry 4096. Furthermore, an audio I/O 4090 may couple to second bus 4091. Many of the I/O devices 4092, communication devices 4086, and the data storage unit 4088 may reside on the motherboard 4005 while the keyboard 4082 and the mouse 4084 may be add-on peripherals. In other embodiments, some or all the I/O devices 4092, communication devices 4086, and the data storage unit 4088 are add-on peripherals and do not reside on the motherboard 4005.

FIG. 5 illustrates an example of a storage medium 5000 to store input data structure generation logic and function data structures. Storage medium 5000 may comprise an article of manufacture. In some examples, storage medium 5000 may include any non-transitory computer readable medium or machine readable medium, such as an optical, magnetic or semiconductor storage. Storage medium 5000 may store various types of computer executable instructions, such as instructions to implement logic flows and/or techniques described herein. Examples of a computer readable or machine-readable storage medium may include any tangible media capable of storing electronic data, including volatile memory or non-volatile memory, removable or non-removable memory, erasable or non-erasable memory, writeable or re-writeable memory, and so forth. Examples of computer executable instructions may include any suitable type of code, such as source code, compiled code, interpreted code, executable code, static code, dynamic code, object-oriented code, visual code, and the like. The examples are not limited in this context.

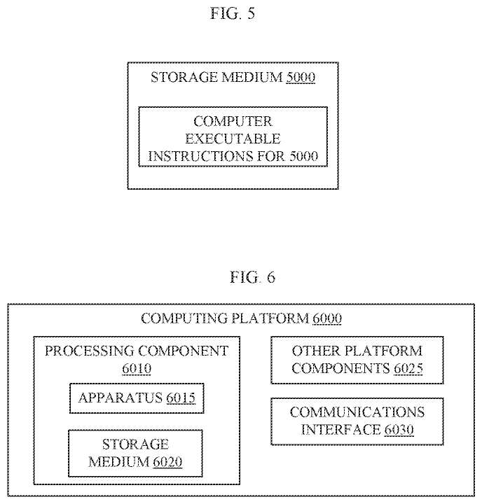

FIG. 6 illustrates an example computing platform 6000. In some examples, as shown in FIG. 6, computing platform 6000 may include a processing component 6010, other platform components or a communications interface 6030. According to some examples, computing platform 6000 may be implemented in a computing device such as a server in a system such as a data center or server farm that supports a manager or controller for managing configurable computing resources as mentioned above. Furthermore, the communications interface 6030 may comprise a wake-up radio (WUR) and may be capable of waking up a main radio of the computing platform 6000.

According to some examples, processing component 6010 may execute processing operations or logic for apparatus 6015 described herein such as the input data generation logic circuitry 1015, 1115, and 1125 illustrated in FIGS. 1A and 1B. Processing component 6010 may include various hardware elements, software elements, or a combination of both. Examples of hardware elements may include devices, logic devices, components, processors, microprocessors, circuits, processor circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements, which may reside in the storage medium 6020, may include software components, programs, applications, computer programs, application programs, device drivers, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given example.

In some examples, other platform components 6025 may include common computing elements, such as one or more processors, multi-core processors, co-processors, memory units, chipsets, controllers, peripherals, interfaces, oscillators, timing devices, video cards, audio cards, multimedia input/output (I/O) components (e.g., digital displays), power supplies, and so forth. Examples of memory units may include without limitation various types of computer readable and machine readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory), solid state drives (SSD) and any other type of storage media suitable for storing information.

In some examples, communications interface 6030 may include logic and/or features to support a communication interface. For these examples, communications interface 6030 may include one or more communication interfaces that operate according to various communication protocols or standards to communicate over direct or network communication links. Direct communications may occur via use of communication protocols or standards described in one or more industry standards (including progenies and variants) such as those associated with the PCI Express specification. Network communications may occur via use of communication protocols or standards such as those described in one or more Ethernet standards promulgated by the Institute of Electrical and Electronics Engineers (IEEE). For example, one such Ethernet standard may include IEEE 802.3-2012, Carrier sense Multiple access with Collision Detection (CSMA/CD) Access Method and Physical Layer Specifications, Published in December 2012 (hereinafter “IEEE 802.3”). Network communication may also occur according to one or more OpenFlow specifications such as the OpenFlow Hardware Abstraction API Specification. Network communications may also occur according to Infiniband Architecture Specification, Volume 1, Release 1.3, published in March 2015 (“the Infiniband Architecture specification”).

Computing platform 6000 may be part of a computing device that may be, for example, a server, a server array or server farm, a web server, a network server, an Internet server, a work station, a mini-computer, a main frame computer, a supercomputer, a network appliance, a web appliance, a distributed computing system, multiprocessor systems, processor-based systems, or combination thereof. Accordingly, functions and/or specific configurations of computing platform 6000 described herein, may be included or omitted in various embodiments of computing platform 6000, as suitably desired.

The components and features of computing platform 6000 may be implemented using any combination of discrete circuitry, ASICs, logic gates and/or single chip architectures. Further, the features of computing platform 6000 may be implemented using microcontrollers, programmable logic arrays and/or microprocessors or any combination of the foregoing where suitably appropriate. It is noted that hardware, firmware and/or software elements may be collectively or individually referred to herein as “logic”.

It should be appreciated that the exemplary computing platform 6000 shown in the block diagram of FIG. 6 may represent one functionally descriptive example of many potential implementations. Accordingly, division, omission or inclusion of block functions depicted in the accompanying figures does not infer that the hardware components, circuits, software and/or elements for implementing these functions would necessarily be divided, omitted, or included in embodiments.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores”, may be stored on a tangible, machine readable medium and supplied to various customers or manufacturing facilities to load into the fabrication machines that actually make the logic or processor.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

Some examples may include an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner or syntax, for instructing a machine, computing device or system to perform a certain function. The instructions may be implemented using any suitable high-level, low-level, object-oriented, visual, compiled and/or interpreted programming language.

Some examples may be described using the expression “in one example” or “an example” along with their derivatives. These terms mean that a particular feature, structure, or characteristic described in connection with the example is included in at least one example. The appearances of the phrase “in one example” in various places in the specification are not necessarily all referring to the same example.

Some examples may be described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, but yet still co-operate or interact with each other.

In addition, in the foregoing Detailed Description, it can be seen that various features are grouped together in a single example for the purpose of streamlining the disclosure. This method of disclosure is not to be interpreted as reflecting an intention that the claimed examples require more features than are expressly recited in each claim. Rather, as the following claims reflect, inventive subject matter lies in less than all features of a single disclosed example. Thus, the following claims are hereby incorporated into the Detailed Description, with each claim standing on its own as a separate example. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code to reduce the number of times code must be retrieved from bulk storage during execution. The term “code” covers a broad range of software components and constructs, including applications, drivers, processes, routines, methods, modules, firmware, microcode, and subprograms. Thus, the term “code” may be used to refer to any collection of instructions which, when executed by a processing system, perform a desired operation or operations.

Logic circuitry, devices, and interfaces herein described may perform functions implemented in hardware and also implemented with code executed on one or more processors. Logic circuitry refers to the hardware or the hardware and code that implements one or more logical functions. Circuitry is hardware and may refer to one or more circuits. Each circuit may perform a particular function. A circuit of the circuitry may comprise discrete electrical components interconnected with one or more conductors, an integrated circuit, a chip package, a chip set, memory, or the like. Integrated circuits include circuits created on a substrate such as a silicon wafer and may comprise components. And integrated circuits, processor packages, chip packages, and chipsets may comprise one or more processors.

Processors may receive signals such as instructions and/or data at the input(s) and process the signals to generate the at least one output. While executing code, the code changes the physical states and characteristics of transistors that make up a processor pipeline. The physical states of the transistors translate into logical bits of ones and zeros stored in registers within the processor. The processor can transfer the physical states of the transistors into registers and transfer the physical states of the transistors to another storage medium.

A processor may comprise circuits to perform one or more sub-functions implemented to perform the overall function of the processor. One example of a processor is a state machine or an application-specific integrated circuit (ASIC) that includes at least one input and at least one output. A state machine may manipulate the at least one input to generate the at least one output by performing a predetermined series of serial and/or parallel manipulations or transformations on the at least one input.

The logic as described above may be part of the design for an integrated circuit chip. The chip design is created in a graphical computer programming language and stored in a computer storage medium or data storage medium (such as a disk, tape, physical hard drive, or virtual hard drive such as in a storage access network). If the designer does not fabricate chips or the photolithographic masks used to fabricate chips, the designer transmits the resulting design by physical means (e.g., by providing a copy of the storage medium storing the design) or electronically (e.g., through the Internet) to such entities, directly or indirectly. The stored design is then converted into the appropriate format (e.g., GDSII) for the fabrication.

The resulting integrated circuit chips can be distributed by the fabricator in raw wafer form (that is, as a single wafer that has multiple unpackaged chips), as a bare die, or in a packaged form. In the latter case, the chip is mounted in a single chip package (such as a plastic carrier, with leads that are affixed to a motherboard or other higher-level carrier) or in a multichip package (such as a ceramic carrier that has either or both surface interconnections or buried interconnections). In any case, the chip is then integrated with other chips, discrete circuit elements, and/or other signal processing devices as part of either (a) an intermediate product, such as a processor board, a server platform, or a motherboard, or (b) an end product.

What is claimed is:

1. An apparatus comprising:
memory; and
logic circuitry coupled with the memory to:
convert the input values for an input layer of the neural network into function data structures representing constants and formulas with variables;
for each layer of the neural network after the input layer, proceeding from the layer closest to the input layer to the desired output node:
for each node in the layer:
if the layer is the output layer, and a current node is not going to be used as a constraint or objective function (or solved for, in the case of limit analysis), continue to the next node without doing further work;
otherwise,
construct a new graph, consisting of an activation function vertex, and a child Sum vertex, the sum being an argument for the activation function vertex;
for each connection between the current node and the nodes in the prior layer, add a child to the Sum vertex that is a Multiply vertex, whose children in turn are a constant containing the weight of the connection to the prior node, and the graph representing the value of the prior node; and
add another child to the Sum vertex comprising a constant containing the bias value; and
retrieve the directed acyclic graphs used as the values from the desired output nodes;
for each output node to be used as a constraint, or to be solved for limit analysis, construct a comparison vertex against a “passing” value, using the output node's graph and the passing value as the children; and pass the graph corresponding to the output node to the optimizer;
and/or for each output node to be used as an objective function, pass the graph corresponding to the output node to the optimizer.

2. The apparatus of claim 1, wherein the function data structures comprise a tree-based or graph-based data structure.

3. The apparatus of claim 2, wherein the function data structures comprise a directed acyclic graph (DAG).

4. The apparatus of claim 3, wherein vertex types of the DAG comprise two or more vertex types in a group of vertex types comprising sum operation, arithmetic operation, variables, constant values, activation function, comparison operations, division operations, and subtraction operations.

3. The apparatus of claim 3, wherein each input node of the neural network comprises a directed acyclic graph (DAG).

5. The apparatus of claim 1, the activation function having a single child that is the argument to the function.

6. The apparatus of claim 1, the activation function being a DAG of mathematical operations, with the single child to be used as the argument utilized as a child at one or more places in the graph.

7. The apparatus of claim 1, the comparison operations comprising two or more operations in a group of operations comprising equal, not equal, greater than, greater than or equal, less than, and less than or equal.

8. A system described in one or more of in claims 1-7, wherein the logic circuitry comprises processing circuitry, memory coupled with the processing circuitry, a communications interface coupled with the processing circuitry, and data storage coupled with the processing circuitry, wherein the processing circuitry comprises one or more processors residing in one or more servers, wherein the memory comprises memory in the one or more servers, and the data storage comprises data storage residing in or coupled with the server, wherein the data storage further comprises data storage elements residing in other servers coupled with the one or more servers, wherein the memory comprises code executable by the processing circuitry, wherein the code is distributed in whole or in part between memory in one or more of the one or more servers and/or residing in the data storage.

9. A non-transitory storage medium containing instructions, which when executed by a processor, cause the processor to perform operations, the operations to perform the functionality described in claims 1-7.

10. An apparatus comprising:
memory; and
logic circuitry coupled with the memory to
convert the input values for an input layer of the neural network to function data structures, each input value associated with a different input node, each of the input nodes to represent a constant or a formula with one or more variables;
create a new neural network type of vertex, the new neural network type of vertex comprising:
a child vertex per input node;
a three dimensional array of weights comprising a first dimension to represent a current layer, a second dimension to represent a current node in the current layer, and a third dimension to represent a current weight between the current node and a prior node; and
an index of an output node to be evaluated in the output layer;
wherein the value of each node is represented by a function data structure;
wherein each vertex in the function data structure has a method solve that evaluates the vertex;
pass the graph of the function data structure corresponding to the output node to the optimizer.

11. A system described in one or more of in claims 1-7 and 10, wherein the logic circuitry comprises processing circuitry, memory coupled with the processing circuitry, a communications interface coupled with the processing circuitry, and data storage coupled with the processing circuitry, wherein the processing circuitry comprises one or more processors residing in one or more servers, wherein the memory comprises memory in the one or more servers, and the data storage comprises data storage residing in or coupled with the server, wherein the data storage further comprises data storage elements residing in other servers coupled with the one or more servers, wherein the memory comprises code executable by the processing circuitry, wherein the code is distributed in whole or in part between memory in one or more of the one or more servers and/or residing in the data storage.

12. A non-transitory storage medium containing instructions, which when executed by a processor, cause the processor to perform operations, the operations to perform the functionality described in claims 1-7 and 10.

13. An apparatus comprising:
memory; and
logic circuitry coupled with the memory to
Accept as arguments to a function evaluateNode a specified layer i (with input layer being I=0 and output layer being I=# of layers−1) and a node within that layer j for nodes in the input layer, call solve on the graph corresponding to specified input node j and return result as the current node's value; and
Otherwise, assign value 0 to variable sum and for each node in the prior layer (represented by numeric index k):
call evaluateNode, passing i−1 for the layer and k for the node, to determine the result of evaluation for the prior node
evaluate the multiplication of the prior call to evaluateNode by the weight between the current node and node in the prior layer, ωᵢⱼₖ in array ω;
assign the addition of the product of the prior multiplication and the current value of the variable sum, to the variable sum;
assign the addition of the bias and the current value of the variable sum, to variable sum;
evaluate the activation function on variable sum, as required by the optimizer (or limit analysis), either by calling solve on a graph equivalent to the activation function, or embedding the corresponding logic within the NeuralNetwork vertex itself; and
return the value of the evaluation of the activation function as current node's value; and
have the solve method of the Neural Network vertex call evaluateNode, passing the output layer (i=# of layers−1), and the particular output node to evaluate (j); and
pass the Neural Network vertex to the optimizer, if it is to be used as an objective function;
Or pass a comparison vertex with children being the Neural Network vertex and a graph representing the passing value, if it is to be used as a constraint to an optimizer, or if it is to be passed to a limit analyzer.

14. A system described in one or more of in claims 1-7, 10, and 13, wherein the logic circuitry comprises processing circuitry, memory coupled with the processing circuitry, a communications interface coupled with the processing circuitry, and data storage coupled with the processing circuitry, wherein the processing circuitry comprises one or more processors residing in one or more servers, wherein the memory comprises memory in the one or more servers, and the data storage comprises data storage residing in or coupled with the server, wherein the data storage further comprises data storage elements residing in other servers coupled with the one or more servers, wherein the memory comprises code executable by the processing circuitry, wherein the code is distributed in whole or in part between memory in one or more of the one or more servers and/or residing in the data storage.

15. A non-transitory storage medium containing instructions, which when executed by a processor, cause the processor to perform operations, the operations to perform the functionality described in claims 1-7, 10, and 13.

16. An apparatus comprising:
memory; and
logic circuitry coupled with the memory to
prepare two arrays of intermediate results, with lengths equal to the maximum number of nodes in a layer, referred to as currResults and priorResults; and
for each layer in the neural network (represented by numeric index i, with the input layer being layer i=0 and the output layer being i=# of layers−1);
for each node in that layer (represented by numeric index j):
if the layer is the input layer (when i=0); then
call solve on the graph corresponding to the current input node j; and
store the result in currResultsⱼ;
if the layer is the output layer and j is not equal to the index of the desired output node being evaluated continue without doing any work;
Otherwise assign value 0 to variable sum;
for each node in the prior layer (represented by numeric index k), perform a multiplication of priorResultsₖ by weight ωᵢⱼₖ and add the product to variable sum;
add the bias to variable sum;
evaluate the activation function on variable sum, as required by the optimizer (or limit analysis), either by calling solve on a graph equivalent to the activation function, or embedding the corresponding logic within the NeuralNetwork vertex itself;
store the result of that evaluation of the activation function in currResultsⱼ;
swap currResults and priorResults with each other;
return the result stored in priorResults at the index of the desired output node; and
pass the graph corresponding to the output node to the optimizer as an objective function;
or use the graph corresponding to the output node as a child vertex of a comparison vertex, with the other vertex of the comparison graph corresponding to a “passing” value, and pass the comparison graph to the optimizer as a constraint, or to a limit analyzer for solving.

17. A system described in one or more of in claims 1-7, 10, 13, and 16, wherein the logic circuitry comprises processing circuitry, memory coupled with the processing circuitry, a communications interface coupled with the processing circuitry, and data storage coupled with the processing circuitry, wherein the processing circuitry comprises one or more processors residing in one or more servers, wherein the memory comprises memory in the one or more servers, and the data storage comprises data storage residing in or coupled with the server, wherein the data storage further comprises data storage elements residing in other servers coupled with the one or more servers, wherein the memory comprises code executable by the processing circuitry, wherein the code is distributed in whole or in part between memory in one or more of the one or more servers and/or residing in the data storage.

18. A non-transitory storage medium containing instructions, which when executed by a processor, cause the processor to perform operations, the operations to perform the functionality described in any one or more of claims 1-7, 10, 13, and 16.
